(19) United States
(12) Patent Application Publication
(10) Pub. No.: US 2002/0094077 A1
(43) Pub. Date: Jul. 18, 2002

(54) Subscriber circuit and method for the internal functional testing of a subscriber circuit

(76) Inventor: Paul Kunisch, Puchheim (DE)

Correspondence Address: BELL, BOYD & LLOYD, LLC, P. O. BOX 1135, CHICAGO, IL, 60690-1135, US

(21) Appl. No.: 10/020,615

(22) Filed: Dec. 13, 2001

(30) Foreign Application Priority Data
Dec. 14, 2000 (DE) 100 62 374.3

(51) Int. Cl. H04M 1/00; H04M 1/24

(52) U.S. Cl. 379/387.01; 379/1.01; 379/27.01

(57) ABSTRACT

A subscriber circuit and method for the internal functional testing of the subscriber circuit, wherein the circuit contains at least one signal processor, with a control device, an evaluation device and a device for generating test signals, at least one A/D converter and at least one high voltage part, a circuit arrangement for line monitoring of the subscriber circuit with a number of switches being provided in the at least one high voltage part, and wherein the control device is configured such that all the switches are closed in a test operating state.

### BACKGROUND OF THE INVENTION

In modern telecommunications systems, in most cases there is an integrated SLIC (Subscriber Line Interface Circuit) in a subscriber circuit, the SLIC module integrating not only functions for voice transmission, subscriber supply, a call, toll pulses, etc., but also, for example, functions for line monitoring. The line monitoring serves to detect a loop connection, a ground connection, etc. This makes it possible to detect whether a subscriber picks up the receiver of his/her analog subscriber apparatus so that a dial tone and a current, for example, are sent to the subscriber apparatus for the connection setup.

In order to ensure that the various functions of the subscriber circuit function correctly, testing devices are necessary.

Thus, it is possible to use an external test device to test whether a subscriber line is operationally capable by, for example, switching on to the line of the respective subscriber via a relay and sending a test signal through the subscriber line. However, if the hardware of the subscriber circuit is to be checked more precisely, the external test device must have exact knowledge as to what technology the subscriber circuit contains. This is problematic because, as development progresses, new components may always be present. Checking by using an external test device is, therefore, only a coarse test and is not used for precisely checking the components of a subscriber circuit.

A more comprehensive determination of the individual functions of a subscriber circuit can be achieved by electrically isolating the subscriber line and connecting a reference impedance using a relay. With this test which is carried out during the operation of the subscriber circuit, a high testing depth is achieved but the testing lasts a very long time. In addition, influences such as aging, temperature etc. have to be taken into account in a comparison with tolerance limits and, last but not least, complex measures are necessary in order to prevent the subscriber being disrupted during the switching over of the relay.

For a rapid functional test result, without electrical isolation of the subscriber line, what is referred to as a quick circuit test is presently carried out and is integrated as a test function for self-testing in the subscriber circuit. Here, the capacitance measurement is carried out using a sinusoidal signal. A capacitance value which is determined in this way is then compared with a lower threshold value. When a subscriber line is connected, this determined capacitance value should be greater than the capacitances (EMC capacitors) which are implemented via hardware. However, because only the presence of the EMC capacitors has to be checked, only partial functions of the subscriber circuit can be registered and tested. Moreover, the quick circuit test is dependent on EMC capacitors being present.

In contemporary subscriber circuits, the external wiring of the SLIC is modified by increasing the bandwidth from currently 16 kHz (toll pulses) to 552 kHz or 1.1 MHz. This is manifested in a drastic reduction of EMC capacitors to <1 nF. However, owing to this reduction, the quick circuit test no longer delivers any usable results.

An object of the present invention is, therefore, to make available a subscriber circuit which permits comprehensive and uncomplicated internal functional testing, independently of the external wiring of the subscriber circuit, without carrying out electrical isolation of the subscriber line. Moreover, a method is to be developed for internal functional testing of this subscriber circuit.

### SUMMARY OF THE INVENTION

Accordingly, the inventor proposes to develop a subscriber circuit as a connecting element between an analog part and a digital part of a telephone network, having at least one “a” telecommunications wire and one “b” telecommunications wire, where:

the known subscriber circuit contains at least one signal processor, at least one A/D converter and at least one high voltage part;

in the at least one high voltage part a first amplifier is provided downstream of an analog input and is connected to the a telecommunications wire via a current sensor, a first switch and an input/output;

a second amplifier is provided downstream of the analog input and is connected to the b telecommunications wire via a second current sensor, a second switch and a second input/output;

the two current sensors lead to a measuring element which is connected to an analog output of the high voltage part;

a line which leads to the measuring element via a third switch, a resistor and a third current sensor is provided between the first switch and the first input/output;

a line which leads to the measuring element via a fourth switch, a further resistor and a fourth current sensor being provided between the second switch and the second input/output; and

at least one device for generating test signals, a control device for controlling the switches and an evaluation device for evaluating incoming signals are provided in the at least one signal processor.

The control device is configured in such a way that, in a test operating mode, all the switches are closed.

In the at least one high voltage part, a circuit arrangement for line monitoring of the subscriber circuit is therefore provided with a multiplicity of switches. Line monitoring is implemented in the state of rest with the telephone receiver on the hook by connecting the resistors; that is to say, by closing the corresponding third and fourth switches, and opening the first and second switches. In active operating states, if, for example, a subscriber telephones or a call is received, the resistors integrated in the high voltage part are switched off by opening the third and fourth switches. At the same time, in the active operating states the first and second switches are closed.

By introducing, according to the present invention, a new, additional operating state (test operating state) in which the resistors are not switched off in the test mode, these resistors advantageously can be used as terminating resistors or reference resistors. All these switches of the high voltage part are therefore closed in the test operating mode.

A preferred embodiment of the subscriber circuit according to the present invention provides for the device for the generation of test signals to be configured in such a way that, in order to avoid a fault at the subscriber, for example the response of an alarm clock (ringing tone), a signal is generated with a frequency which is less than 16 Hz or greater than 54 Hz. This signal, the generated test signal, should therefore lie outside the range for the ringing tone detection of the alarm clock.

In a further advantageous embodiment of the subscriber circuit according to the present invention, the circuit for the generation of test signals is configured in such a way that, in order to avoid a fault at the subscriber, a signal is generated which has an amplitude which lies below the response threshold of ringing tone detector circuits and of alarm clocks. For example, the test signal can have an amplitude which is less than 15V.

Furthermore, the device for the generation of test signals can be configured in such a way that a modified toll pulse signal is generated as test signal, the toll pulse signal either being shorter than the response time of the metering device or being transmitted with a frequency outside the response threshold so that the transmitted signal does not lead to any metering at the subscriber. The functionality of the toll pulse feeding part can be checked from the obtained measurement signal by comparison with a set point value.

In another embodiment of the subscriber circuit according to the present invention, the device for generating test signals is configured in such a way that a d.c. voltage is generated as test signal. A center voltage is preferably set via the amplifiers so that the same current flows through the two resistors but in different directions. If measurement is then carried out with different voltages, it is possible to check if the obtained measured values coincide with stored reference values.

By measuring leakage currents in the state of rest and by programming different wire voltages in the call state and in the test mode, the direct current paths (d.c. paths) including the indications (response thresholds for loop connection) can be checked via current or voltage measurements. Here, two different voltages are successively set at the amplifiers of the subscriber circuit and, in each case, the currents which flow through the resistors of the subscriber circuit are measured. Because it is known which current should flow through these resistors, it is possible to use this two-point measurement to calculate the leakage current on the line and determine the measuring accuracy of d.c. currents.

The functional testing of the indication (loop connection), can be permitted by programming indication thresholds. If, on the one hand, the threshold is programmed lower than the d.c. value, in the fault-free state the indication should respond. On the other hand, in the fault-free state the indication should not respond if the threshold is programmed higher than the d.c. value.

Other developments of the subscriber circuit according to the present invention provide for the device for generating test signals to be configured in such a way that an alternating voltage is generated as test signal. By generating alternating voltages (sinusoidal signal, ramp, etc.) and measuring the alternating currents through the resistors, it is possible to check the alternating current paths (a.c. paths).

Furthermore, the inventor proposes a method for the internal functional testing of a subscriber circuit which functions as a connecting element between an analog part and a digital part of a telephone network with a/b telecommunications wires. The subscriber circuit contains at least one signal processor, at least one A/D converter and at least one high voltage part, and having a number of switches. A state of rest and an active operating state of an analog subscriber apparatus which is connected to the subscriber circuit is implemented by different settings of the switches, a test signal within the subscriber circuit is output for functional testing, and a measured value is compared with a reference value and evaluated. The method is developed to the effect that in a test operating state all the switches are closed.

In the active operating state, only the switches which bring about a connection of the subscriber circuit to the telecommunications wires are closed and all the others are opened. However, in the state of rest, the switches for connection to the telecommunications wires are opened and the other switches are closed. Only in the new test operating state does a control device bring about the closing of all the switches of the high voltage part. If test signals are generated in the method according to the present invention for the internal functional testing of the subscriber circuit or the components of the subscriber circuit and conducted through the subscriber circuit, the closing of all the switches can ensure that capacitors are not required and electrical isolation and connection of an additional testing impedance does not take place for the internal test.

For the functional testing of the subscriber circuit, at least one test signal is advantageously generated which at least partially simulates functions of the subscriber circuit; that is to say, for example, functions for the transmission of voice, the feeding of subscribers, the call and toll pulses. The test signal is conducted through the circuit and brings about the outputting of a measurement signal, it being possible for the measurement signal to be obtained from current or voltage measurements. This measurement signal can be compared with a stored reference value and evaluated.

In the evaluation of the obtained measured value, a tolerance can be assumed with respect to how large the deviation of the measured value from the reference value may be before a measured value may be evaluated as a fault. For example, this tolerance can be +/−15% deviation.

In an advantageous embodiment of the method according to the present invention, a signal with a frequency which is less than 16 Hz and/or greater than 54 Hz is generated as test signal in order to avoid a ringing tone at the subscriber.

Furthermore, in order to avoid a ringing tone, a signal which has an amplitude which lies below a response threshold of a ringing tone detector circuit or below the response threshold of an alarm clock can be generated as test signal.

One embodiment of the method according to the present invention provides for internal functional testing to be carried out on a routine basis, for example at intervals of a few minutes, as long as no active operating state of the subscriber circuit applies. It is therefore possible to switch from a state of rest into the test operating state and, preferably, a multiplicity of test signals can be conducted in series through the subscriber circuit and evaluated.

The subscriber circuit according to the present invention and the method according to the present invention therefore permit those circuit parts of the subscriber circuit which are provided for line monitoring to be used for functional testing of the subscriber circuit.

Additional features and advantages of the present invention are described in, and will be apparent from, the following Detailed Description of the Invention and the Figures.

### BRIEF DESCRIPTION OF THE FIGURES

FIG. 1 shows a preferred embodiment of the subscriber circuit of the present invention which functions as a connecting element between an analog part and a digital part of a telephone network..

### DETAILED DESCRIPTION OF THE INVENTION

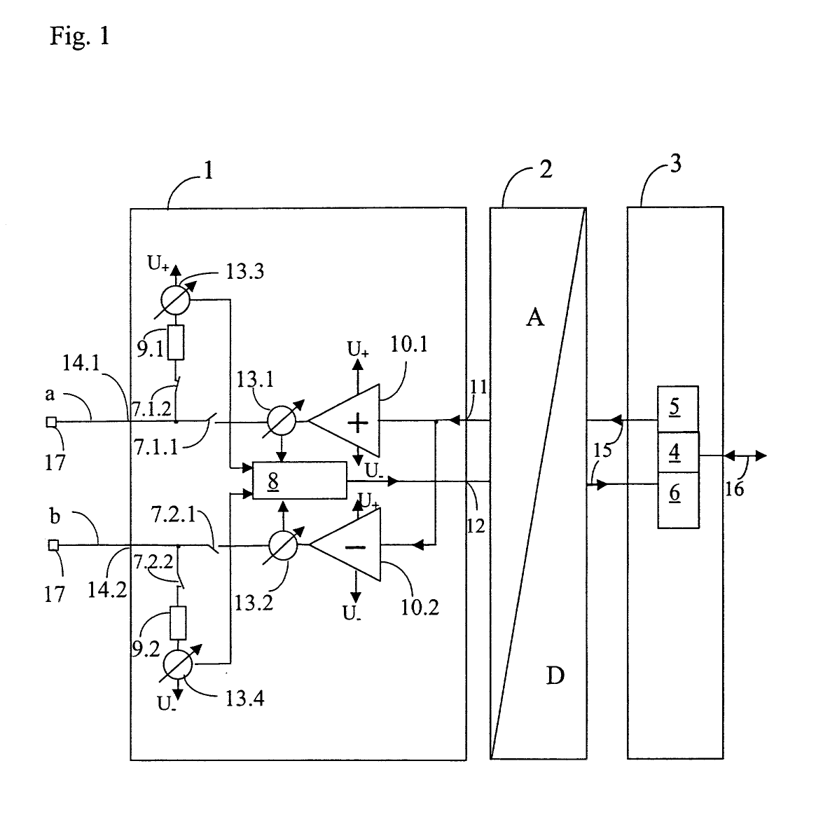

In FIG. 1, the connection to the digital part is symbolized by the double arrows 16, and the connection to the analog part by the markings 17.

The subscriber circuit contains a signal processor 3, an A/D converter 2 and a high voltage part 1, the signal processor 3 being connected via a digital interface to the A/D converter 2 illustrated by the arrows 15. At least one analog interface connects the A/D converter 2 to an analog input 11 and to an analog output 12 of the high voltage part.

FIG. 1 also shows a circuit arrangement of the high voltage part 1 which previously has been used for line monitoring the subscriber circuit. Here, a first amplifier 10.1, a current sensor 13.1 and a switch 7.1.1 are provided between the analog input 11 of the high voltage part 1 and the telecommunications wire a. A second amplifier 10.2, a further current sensor 13.2 and a second circuit 7.2.1 are provided between the analog input 11 and the telecommunications wire b. The current sensors 13.1 and 13.2 are connected to a measuring element 8 which conducts measured values to the A/D converter 2 via an analog output 12 of the high voltage part 1. The switches 7.X.Y of the high voltage part 1 are preferably embodied as electronic switches; for example, semiconductor switches (MOSFET=Metal Oxide Field Effect Transistor).

Furthermore, the high voltage part 1 contains, upstream of an analog input/output 14.1, a resistor 9.1 and a current sensor 13.3 which is connected to the measuring element 8. The resistor 9.1 can be switched on or off using a switch 7.1.2. In parallel to this, the high voltage part 1 contains, upstream of an analog input/output 14.2, a switch 7.2.2, a resistor 9.2 and a current sensor 13.4 which conduct signals to the measuring element 8. The resistors 9.X can be implemented as high impedance resistors each with 5 kΩ or as low impedance resistors each with 250 Ω and an additional current limiter.

The measuring element 8 is embodied in the preferred exemplary embodiment as a current sensor, but it can also represent a voltage sensor. The loop current can be measured both in the state of rest and in the call state (active operating state) with the integrated current sensor 8.

The signal processor 3 contains a device 5 for generating test signals, a control device 4 for controlling the switches 7.X.Y, and an evaluation device 6, for example a level meter, for evaluating incoming signals (measurement signals).

In the active operating state, that is to say when a subscriber telephones, the switches 7.1.1 and 7.2.1 are closed and the switches 7.1.2 and 7.2.2 are opened in order to connect the subscriber circuit to the telecommunications wires a and b. On the other hand, in the state of rest, the switches 7.1.1 and 7.2.1 are opened and the switches 7.1.2 and 7.2.2 are closed. In the state of rest, the resistors 9.1 and 9.2 are therefore connected.

In the test operating state according to the present invention, the control device 4 causes all the switches 7.1.1, 7.1.2, 7.2.1 and 7.2.2 to be closed. The control device 4 has appropriate programming or a program module for this. The resistors 9.1 and 9.2 can be used as terminating resistors in this switch setting.

The control device 4 can, preferably, both automatically bring about closing of the switches 7.X.Y at short intervals and set the subscriber circuit to the test operating state in response to an external signal. This external signal can be supplied by the digital part via 16.

Via what is referred to as a loop back configuration, the entire transmission link of the subscriber circuit can be tested by the signal processor 3 via the D/A converter 2 to the high voltage part 1 and back via the A/D converter 2 to the signal processor 3. A digital test signal is generated by the signal processor 3, transferred via the digital interface into the D/A converter 2, converted there into an analog test signal, conducted to the analog amplifiers 10.1 and 10.2 and passes through the switches 7.X.Y and the resistors 9.X. The current through the resistors 9.X is then measured in the current sensor 8, and the result of this measurement is fed via the analog output 12 to the A/D converter 2, digitized there and conducted via the digital interface 15 into the signal processor 3 and the evaluation device 6. Only if the entire transmission link is fault-free does the result correspond to a reference value.

In summary, a subscriber circuit is described which contains at least one signal processor, with a control device, an evaluation device and a device for generating test signals, at least one A/D converter and at least one high voltage part, a circuit arrangement for line monitoring the subscriber circuit being provided with a number of switches in the at least one high voltage part and all the switches being closed by the configuration of the control device according to the present invention in a test operating state.

Overall, the present invention ensures that functional testing is easily carried out without electrical isolation of the subscriber line, independently of the external wiring of the subscriber circuit. Moreover, a method for internal functional testing of a subscriber circuit is described.

Indeed, although the present invention has been described with reference to specific embodiments, those of skill in the art will recognize that changes may be made thereto without departing from the spirit and scope of the invention as set forth in the hereafter appended claims.

1. A subscriber circuit serving as a connecting element between an analog part and a digital part of a telephone network having at least one first telecommunications wire and one second telecommunications wire, comprising:
at least one high voltage part including first and second amplifiers, first through fourth current sensors, first through fourth switches, an analog input, an analog output, first and second input/outputs, a measuring element and first and second resistors, wherein the first amplifier is provided downstream of the analog input and is connected to the first telecommunications wire via the first current sensor, the first switch and the first input/output, wherein the second amplifier is provided downstream of the analog input and is connected to the second telecommunications wire via the second current sensor, the second switch and the second input/output, wherein the first and second current sensors lead to the measuring element which is connected to the analog output, wherein a line which leads to the measuring element via the third switch, the first resistor and the third current sensor is provided between the first switch and the first input/output, and wherein a line which leads to the measuring element via the fourth switch, the second resistor and the fourth current sensor is provided between the second switch and the second input/output;
at least one A/D converter connected to the at least one high voltage part; and
at least one signal processor connected to the at least one AID converter, the at least one signal processor including at least one device for generating test signals, a control device for controlling the first through fourth switches and an evaluation device for evaluating incoming signals, wherein the control device is configured such that all of the first through fourth switches are closed in a test operating state.

2. A subscriber circuit as claimed in claim 1, wherein the device for generating test signals is configured such that, in order to avoid a fault at a subscriber, the test signal is generated with a frequency which is less than 16 Hz or greater than 54 Hz.

3. A subscriber circuit as claimed in claim 1, wherein the device for generating test signals is configured such that, in order to avoid a fault at a subscriber, the test signal is generated having an amplitude which is below a response threshold of ringing tone detector circuits and alarm clocks.

4. A subscriber circuit as claimed in claim 1, wherein the device for generating test signals is configured such that a modified toll pulse signal is generated as the test signal.

5. A subscriber circuit as claimed in claim 1, wherein the device for generating test signals is configured such that a d.c. voltage is generated as the test signal.

6. A subscriber circuit as claimed in claim 1, wherein the device for generating test signals is configured such that an alternating voltage is generated as the test signal.

7. A method for internal functional testing of a subscriber circuit which functions as a connecting element between an analog part and a digital part of a telephone network with first and second telecommunications wires, the subscriber circuit including at least one signal processor, at least one A/D converter and at least one high voltage part having a plurality of switches, the method comprising the steps of:
implementing a state of rest and an active operating state of an analog subscriber apparatus, which is connected to the subscriber circuit, via different settings of the plurality of switches;
generating a test signal within the subscriber circuit for functional testing, wherein all of the switches are closed in a test operating state; and
comparing and evaluating a measured value with a reference value.

8. A method for internal functional testing of a subscriber circuit as claimed in claim 7, wherein, in order to avoid a ringing tone, the test signal is generated with a frequency which is less than 16 Hz or greater than 54 Hz.

9. A method for internal functional testing of a subscriber circuit as claimed in claim 7, wherein, in order to avoid a ringing tone, the test signal is generated having an amplitude which lies below a response threshold of ringing tone detector circuits and alarm clocks.

10. A method for internal functional testing of a subscriber circuit as claimed in claim 7, wherein a modified toll pulse signal is generated as the test signal.

11. A method for internal functional testing of a subscriber circuit as claimed in claim 7, wherein a d.c. voltage is generated as the test signal.

12. A method for internal functional testing of a subscriber circuit as claimed in claim 7, wherein an alternating voltage is generated as the test signal.

13. A method for internal functional testing of a subscriber circuit as claimed in claim 7, wherein at least one of current measurements and voltage measurements are carried out in order to obtain the measured value.
